(19) United States
(12) Patent Application Publication
(10) Pub. No.: US 2015/0295869 A1
(43) Pub. Date: Oct. 15, 2015

(54) Filtering Electronic Messages

(71) Applicant: Microsoft Corporation, Redmond, WA (US)

(72) Inventors: Weisheng Li, Bothell, WA (US); Kok Wai Chan, Bellevue, WA (US); Rui Chen, Bellevue, WA (US)

(21) Appl. No.: 14/252,249

(22) Filed: Apr. 14, 2014

(51) Int. Cl. H04L 12/58; G06F 17/27

(52) U.S. Cl. CPC H04L 51/12; G06F 17/2785

(57) ABSTRACT

Technologies are described herein for filtering of electronic messages. A method for filtering messages includes receiving an electronic message for transmission to a recipient, generating a fingerprint for the electronic message, determining if the electronic message is associated with a known cluster of previously transmitted electronic messages, and filtering the electronic message based on the determining. The fingerprint is a fixed length of appended bits selected from hash values determined by applying hash functions to separate textual words included in the electronic message.

### BACKGROUND

When processing electronic mail (“email”) messages for transmission to a recipient, an important task is determining if a message to be delivered is classified as unsolicited bulk email (“UBE”). These messages might also be referred to as “spam” or “noisy messages”. The term “noisy messages” will be utilized herein to refer generally to unsolicited electronic messages.

Noisy messages may be sent by individuals manually or with programs that automate dissemination of such messages. Additionally, noisy messages may originate from a fixed location or from a system of automated computer programs (sometimes referred to as a “botnet”). Furthermore, noisy messages may include polymorphic content that is continually changing, thereby increasing the difficulty in classifying these messages as unwanted through conventional message filtering techniques.

Conventional message filtering techniques include originator reputation and filtering, external link reputation and filtering, and keyword filtering. For generating filtering targets, human or machine learning process are normally employed. To make a reasonable learning decision, however, there is typically a need for human labelling of existing samples. Based on human labelling of the existing samples, data mining processes may be utilized and a prediction pattern may be generated for message filtering. As human interaction is a necessary requirement for functioning of the conventional message filtering techniques, system response to newly generated noisy messages that do not fit existing prediction patterns may be very slow.

It is with respect to these considerations and others that the disclosure made herein is presented.

### SUMMARY

Technologies are described herein for filtering of electronic messages, such as email messages. In particular, a fingerprint is created for newly received messages that is compared to fingerprints calculated for known clusters of previously received messages. Based on the comparison, the message and associated cluster may be classified according to a predetermined classification system, and messages may be filtered based on the cluster information. The disclosed fingerprinting, clustering, and classification increases the efficiency of filtering newly received messages and overcomes issues related to polymorphic content of noisy messages. Furthermore, automatic updating of clusters through the techniques described herein decreases a total response time between receipt of new noisy messages and the classification and appropriate filtering of the same.

According to one embodiment presented herein, a method for filtering messages includes receiving an electronic message for transmission to a recipient, generating a fingerprint for the electronic message, determining if the electronic message is associated with a known cluster of previously transmitted electronic messages, and filtering the electronic message based upon the determining. The fingerprint is a fixed length of appended bits selected from hash values determined from hash functions applied to separate textual words included in the electronic message.

According to an additional embodiment presented herein, a mail processing system is configured to distribute electronic messages from a plurality of client computers to a plurality of recipients. The system includes an electronic messaging service configured to receive the electronic messages from the plurality of client computers. The electronic messaging service is further configured to divide each message into a plurality of shingles absent noisy characters. Generally, shingles are groupings of an arbitrary number of textual words obtained from the content of a message. The electronic messaging service is further configured to perform a plurality of hash functions on each shingle of the plurality of shingles to create a plurality of hash values associated with each shingle, and generate a message fingerprint for each message based on the plurality of hash functions.

The system further includes a clustering service configured to receive each message fingerprint from the electronic messaging service. The clustering service is further configured to divide each fingerprint into a plurality of bit sequences, and compare each bit sequence of the plurality of bit sequences to an associated bin of bit sequences for known clusters of previously transmitted electronic messages. The system also includes a filtering agent configured to filter the electronic messages based on filter information received from the clustering service.

It should be appreciated that the above-described subject matter may also be implemented as a computer-controlled apparatus, a computer process, a computing system, or as an article of manufacture such as a computer-readable medium. Although the embodiments presented herein are primarily disclosed in the context of filtering email messages, the concepts and technologies disclosed herein might also be utilized to filter other types of electronic messages and content. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIG. 2 is a flowchart showing aspects of one illustrative routine for filtering electronic messages, according to one embodiment presented herein;

FIG. 3 is a flowchart showing aspects of one illustrative routine for determining a fingerprint of an electronic message, according to one embodiment presented herein;

FIG. 4 is a flowchart showing aspects of one illustrative routine for performing clustering on an electronic message, according to one embodiment presented herein;

FIG. 5 is a flowchart showing aspects of one illustrative routine for determining cluster association of an electronic message, according to one embodiment presented herein;

FIG. 6 is an exemplary table showing organized cluster information for efficient fingerprint similarity determination;

FIG. 7 is a flowchart showing aspects of one illustrative routine for classifying electronic messages, according to one embodiment presented herein; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for automated filtering of electronic messages. Through the use of the technologies and concepts presented herein, relatively fast, accurate, and early electronic message filtering is possible with limited or reduced human labeling and interaction.

As discussed briefly above, conventional electronic message filtering techniques require an observation of unsolicited messages that have already been successfully transmitted through a mail processing system. In order to perform this functionality, samples are collected from the transmitted messages, which are labeled and patterned for comparison to new messages. These comparisons are CPU-intensive tasks that slow conventional systems. Depending upon the results of the comparisons, the new messages may be be filtered to avoid transmission of noisy messages. It follows that as the number of new messages increases, or if new noisy messages include polymorphic or changing content, new samples will be needed for the conventional filtering techniques to function as intended, requiring additional human intervention.

According to embodiments described herein, however, multiple stages of data processing are linked such that a faster response is realized with limited or reduced human interaction. For example, fast clustering of electronic messages, classification of message clusters, and subsequent creation of message filters may be implemented such that limited or reduced human interaction may be required for the filtering of new messages. Feature counting across the clusters may determine a likelihood the cluster can be classified as containing noisy messages. Thereafter, the creation of message filters may be based on an efficiently tailored hash comparison to determine the probability a new message is similar or substantially similar to a cluster of messages, and therefore, constitutes a noisy message that should be filtered.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for filtering electronic messages will be described.

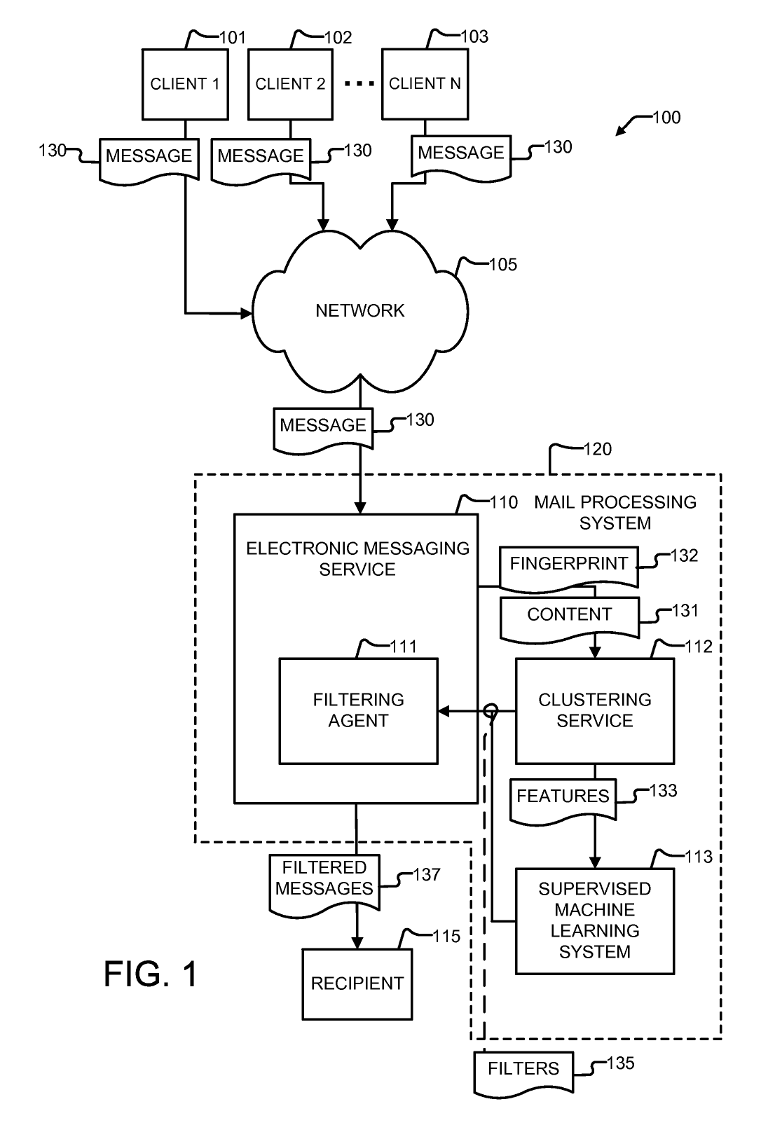

Turning now to FIG. 1, details will be provided regarding an illustrative operating environment and several software components provided by the embodiments presented herein. In particular, FIG. 1 shows aspects of a system 100 for filtering electronic messages. The system 100 includes one or more clients 101, 102, and 103 in operative communication with a mail processing system 120 over a network 105. The clients 101-103 may be any suitable computer systems including, but not limited to, personal computers, tablets, mobile devices, or the like. The network 105 may include a computer communications network such as the Internet, a local area network (“LAN”), wide area network (“WAN”), or any other type of network.

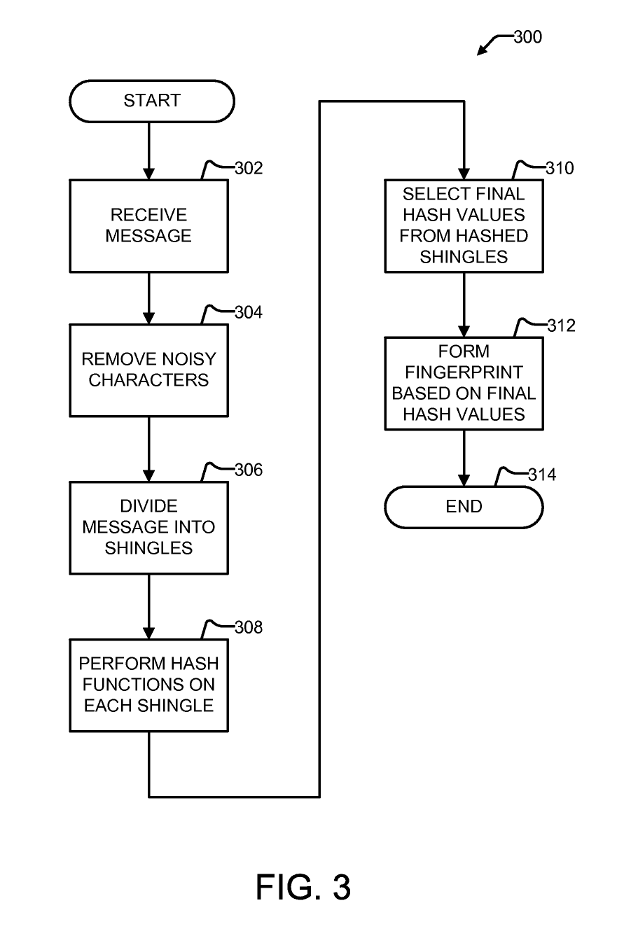

The mail processing system 120 includes several components configured to perform functions as described herein related to filtering of electronic mail messages and, potentially, other types of information. The mail processing system 120 includes an electronic messaging service 110 configured to process messages 130 received from the clients 101-103, filter the messages 130 through a filtering agent 111, and transmit one or more filtered messages 137 to a recipient 115. Generally, a recipient 115 may be a computing device similar to the clients 101-103. The electronic messaging service 110 is also configured to parse messages 130 into message content 131 and create fingerprint 132. The fingerprint 132 is data representative of the message 130 useable for efficient comparisons. Fingerprinting of the message 130 and message content 131 to create the fingerprint 132 is described more fully below with reference to FIG. 3.

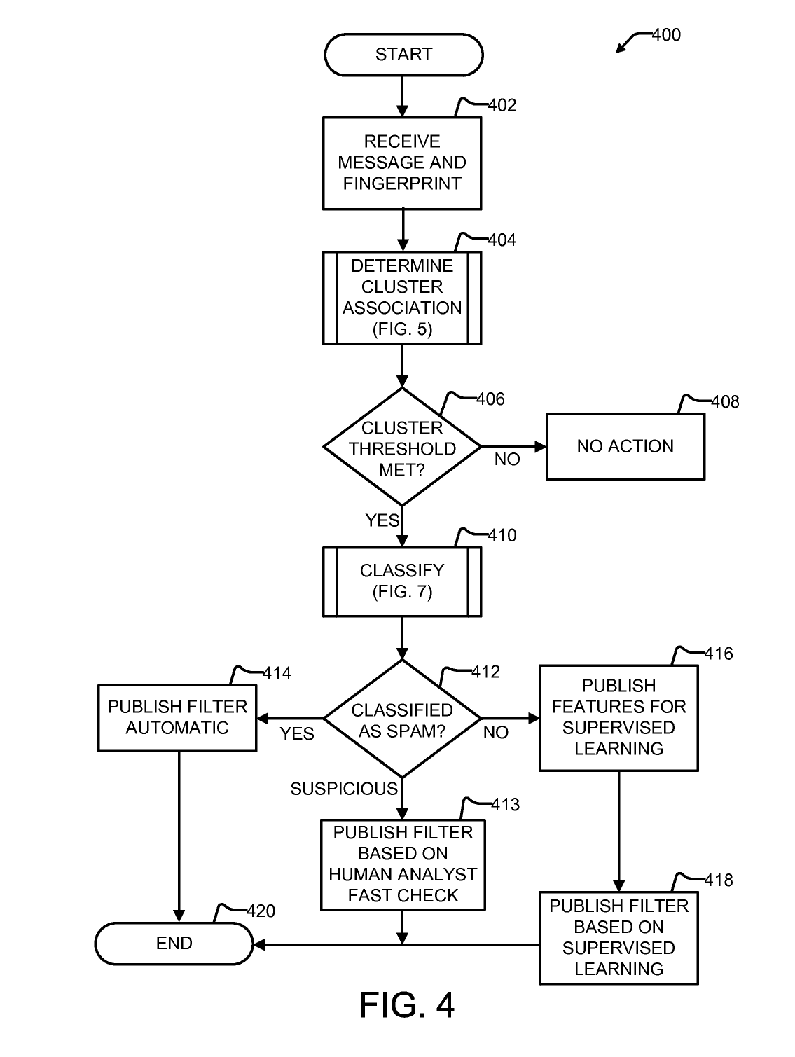

The electronic messaging service 110 is in operative communication with a clustering service 112 configured to execute on the mail processing system 120. The clustering service 112 is configured to receive electronic message content 131 and fingerprint 132 from the electronic messaging service 110, to perform clustering operations with respect to received messages 130, and to provide one or more message filters 135 to the filtering agent 111. Clustering operations will be described more fully below with reference to FIG. 4.

The message content 131 processed through clustering service 112 may include any metadata and content contained within or associated with the messages 130. For example, the content 131 may include sender information, recipient information, origin Internet Protocol (“IP”) information, sender host information, a subject and body content of the message, message identification information, and any other suitable information.

The electronic messaging service 110 and the clustering service 112 are also in operative communication with a supervised machine learning system 113 configured to execute on the mail processing system 120 or another system. The supervised machine learning system 113 is configured to receive electronic message features 133 from the clustering service 112 and to provide one or more of the mail filters 135 to the filtering agent 111. Generally, features 133 may include any suitable features of a cluster of messages including, but not limited to, distinct message subject count and rate, distinct sender count and rate, distinct sender domain count and rate, distinct sender secondary domain count and rate, distinct sender host count and rate, distinct sender secondary host count and rate, distinct sender origin IP count and rate, distinct sender origin count and subnet mask rate, distinct recipient domain rate, distinct recipient secondary domain rate, send to the same domain count and rate, sender host format score, and/or current spam verdict rate. Other features not particularly described here may also be applicable, and are considered to be within the scope of this disclosure.

The supervised machine learning system 113 may perform any suitable form of machine learning using the features 133, message content 131, and other available information. As shown in FIG. 1, messages 130 are transmitted via network 105 to the mail processing system 120 for filtering and subsequent transmission to the recipient 115 as filter messages 137.

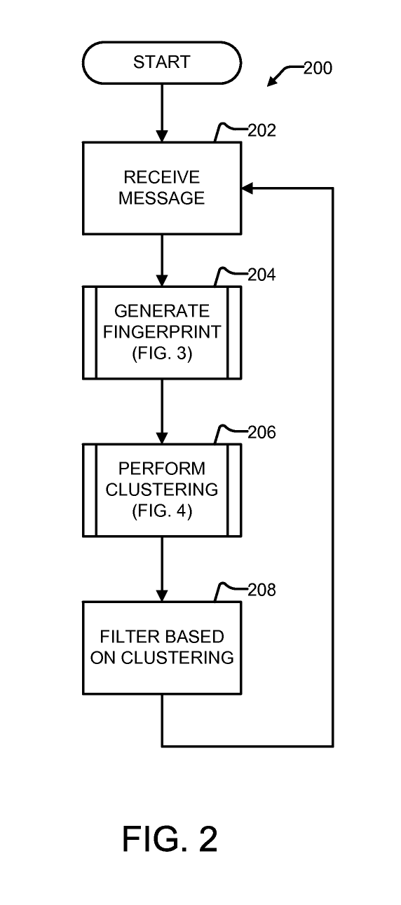

Referring now to FIG. 2, additional details will be provided regarding the embodiments presented herein for filtering of electronic messages 130. In particular, FIG. 2 is a flow diagram illustrating aspects of a method 200 for filtering electronic messages. The method 200 includes receiving a message (e.g., message 130) at block 202. The message may be an electronic mail message, another type of electronic message suitable for electronic transmission to one or more recipients, or potentially another type of content. Upon receiving the message 130 at block 202, the method 200 includes generating a fingerprint for the received message at block 204. Fingerprinting of messages is described more fully below with reference to FIG. 3.

After fingerprinting, the method 200 continues by performing clustering operations on content 131 of the message 130 based on the fingerprint at block 206. Clustering operations are described more fully with reference to FIG. 4. Thereafter, the method 200 continues with filtering of the received message 130 based on the clustering operations at block 208, and iterates through operations 202-208 continually as new messages are received for processing.

Generally, method 200 may be executed by a mail processing system similar to system 120. Fingerprinting operations may be executed by the electronic messaging service 110 and the resulting fingerprint and message content provided to the clustering service 112. The clustering service may use the content and fingerprint for performing operations at block 206, and may subsequently provide a message filter 135 to the filtering agent 111 for filtering of messages (including the message received at step 202). Hereinafter, fingerprinting of received messages is described more fully with reference to FIG. 3.

FIG. 3 is a flowchart showing aspects of one illustrative method 300 for determining a fingerprint of an electronic message 130, according to one embodiment presented herein. The method 300 includes receiving an electronic message (e.g., message 130) at block 302. Thereafter, the method 300 continues by removing noisy characters from the content of the message at block 304. Examples of noisy characters include, but are not limited to, common words such as “and,” “the,” “but,” “or,” “as,” noisy characters such as acupunctures, invisible characters, tags, or any other character/word that may not be important in deciphering an overall content of a message.

Upon removing noisy characters, the method 300 continues by dividing the remaining message content into shingles at block 306. The term “shingle” or “shingles” is utilized herein to refer to a N-gram of a fixed number of textual words or characters from a message 130 tailored in size for efficient computation. According to one embodiment, each shingle may include between three and five textual words selected from the message 130. Other discrete numbers of textual words may be included without departing from the scope of embodiments.

The method 300 subsequently processes the shingles by performing one or more hash functions on each shingle at block 308. The hash functions are configured to return a fixed length hash value from the arbitrary information contained in each shingle. More clearly, as each shingle may contain an arbitrary number of words, the hash functions are tailored to return a value having the same number of bits which is not reliant on the particular number of words in each shingle. Therefore, even if each shingle contains different information and a different number of textual words, the hash functions regularly return hash values of the same fixed bit length.

Thereafter, final hash values are selected from the hashed shingles at block 310. The final hash values may be selected as the minimum hash value for a particular hash function across all shingles. As any message may contain an arbitrary number of shingles depending upon an actual number of textual words contained therein, by selecting a fixed number of hash values to be performed for all shingles, and then selecting the minimum hash value across all shingles, a fixed number of final hash values for any length of message is realized. Therefore, actual message size for any received message will not alter the number of final hash values from a fixed value. It is noted that other hash values may be used as final hash values instead of the minimum in some embodiments. For example, maximum, mean, or other hash values may also be used in different implementations.

According to one embodiment, a total of thirty-two hash functions are performed on each shingle. Thereafter, the minimum value of each hash function is selected as a final hash value that results in a total of thirty-two final hash values for any received message.

Upon selecting the final hash values, the method 300 continues by forming a fingerprint for the received message based on the final hash values at block 312. The fingerprint may be formed by selecting a fixed number of bits from the same location in each final hash value. For example, according to one embodiment, the first two bits of each final hash value are retained and appended head-to-tail, and thus a sixty-four bit fingerprint is created.

In other embodiments, the last two bits of each final hash value are retained and appended head-to-tail, and thus a sixty-four bit fingerprint is created. According to these examples, the fingerprint created is a sequence of bits [0:63] including discrete bits selected from each final hash value. Alternatively, a single bit may be retained and appended to subsequent bits to create a thirty-two bit fingerprint. It is noted that other modifications including other differing numbers of bits might also be applicable to embodiments.

Finally, upon successful creation of a fingerprint for the message received at block 302, the method 300 ends at block 314. The method 300 may also be configured to iterate back through blocks 302-312 for creating additional fingerprints for newly received messages.

As noted above with reference to FIG. 2 and the method 200, block 204 includes performing clustering operations on a message 130. FIG. 4 is a flowchart showing aspects of one illustrative method 400 for performing clustering on an electronic message 130, according to one embodiment presented herein. It is noted that the method 400 may be executed in a sliding time window in some embodiments such that trend information may be discerned in addition to those features described below.

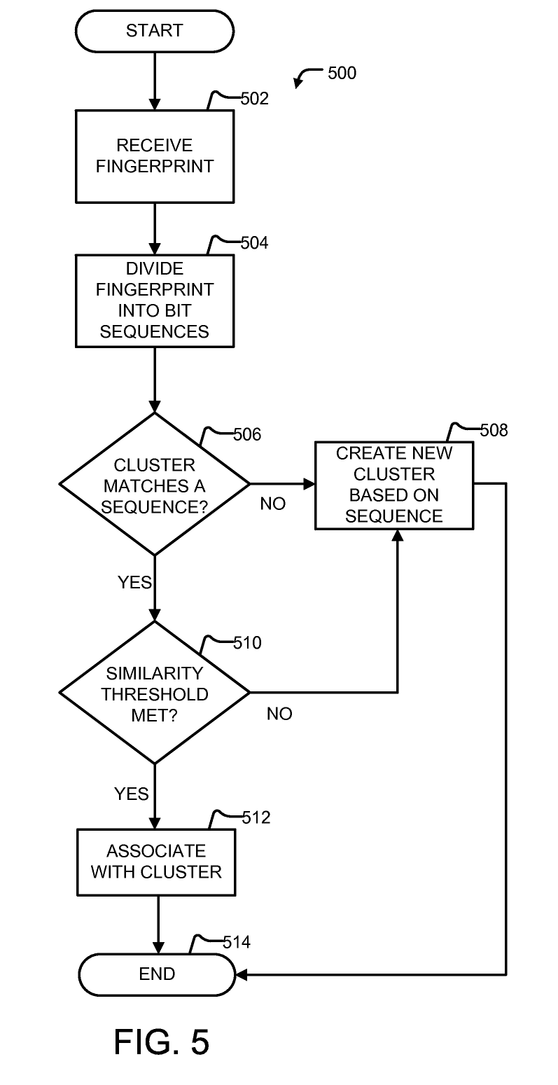

The method 400 includes receiving a message (or message content) and the associated fingerprint at block 402. For example, the fingerprint may be determined through processing of method 300 and may be used in method 400. Thereafter, a cluster associated for the message is determined at block 404. Determining cluster association is described more fully below with reference to FIG. 5.

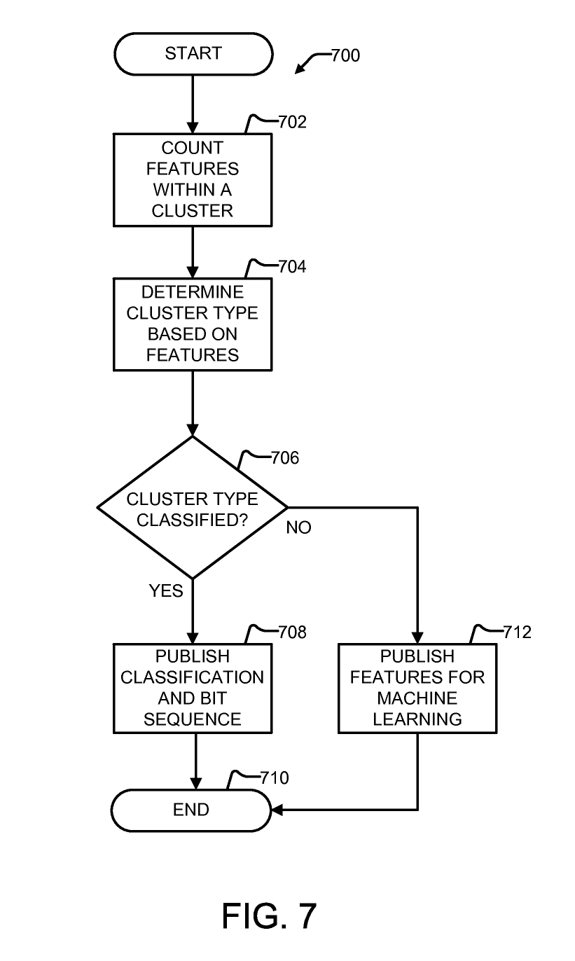

If a threshold for the determined cluster has not been met as determined in block 406, no further action for the received message is taken as shown in block 408. However, if a threshold has been met, the method 400 continues by classifying the received message at block 410. Classification of received messages based on the associated clusters is described more fully below with reference to FIG. 7.

The method 400 then determines whether the classification for the received message is a noisy message, spam, internal bulk message, external bulk message, small community bulk message, botnet bulk message, suspicious, or unclassified message at block 412. More or fewer classifications may be implemented according to any desired function, and these particular classifications are not limiting of the embodiments presented herein.

As used herein, the term internal bulk message is utilized to refer to a message sent from a relatively small number of originators (e.g., one or two) to multiple recipients in the same domain. As used herein, the term external bulk message is utilized to refer to a message sent from a relatively small number of originators (e.g., one or two) to multiple recipients in multiple domains. As used herein, the term small community bulk message is utilized to refer to a message sent from a handful of originators to a handful of recipients in multiple domains. A handful may be more than one originator but less than five in some embodiments. As used herein, the term botnet bulk message is utilized to refer to a message sent for a relatively large number of originators to a relatively large number of recipients. Unclassified messages may include messages not decipherable using the above criteria as determined through application of one or more thresholds. For example, these thresholds may be predetermined or selected based on a desired functioning of the mail processing system.

If the message is classified as suspicious, a review of the suspicious message may be performed by a human analyst at block 413, a filter 135 based on the review is provided if necessary, and the method ceases at block 420. If the message is classified as a noisy message, a filter 135 is automatically provided at block 414 that is tailored to filter out similar messages, and the method 400 ceases at block 420. The filter 135 can be constructed as a message fingerprint as described above, such that new messages at least partially matching the filter fingerprint are subsequently filtered. Furthermore, the filter 135 can include Internet Protocol addresses for a message sender, message sender domain information, or other features statistically significant in the determined classification.

If the message is determined to be unclassified, the method 400 includes publishing features for supervised learning at block 416, publishing one or more filters based on the supervised learning at block 418, and ceasing at block 420.

As noted with reference to step 404, a cluster association is determined for the received message. FIG. 5 is a flowchart showing aspects of one illustrative method 500 for determining cluster association of an electronic message, according to one embodiment presented herein. The method 500 includes receiving a message fingerprint at block 502. The message fingerprint may be created as described above, and may be a fixed length. According to this example, the fingerprint is a 64 bit number containing bits selected from final hash values of message shingles. Other lengths and types of fingerprints are also applicable to other embodiments. The method 500 continues by dividing the received fingerprint into multiple bit sequences at block 504, and determining if any known cluster of messages matches a bit sequence at block 506.

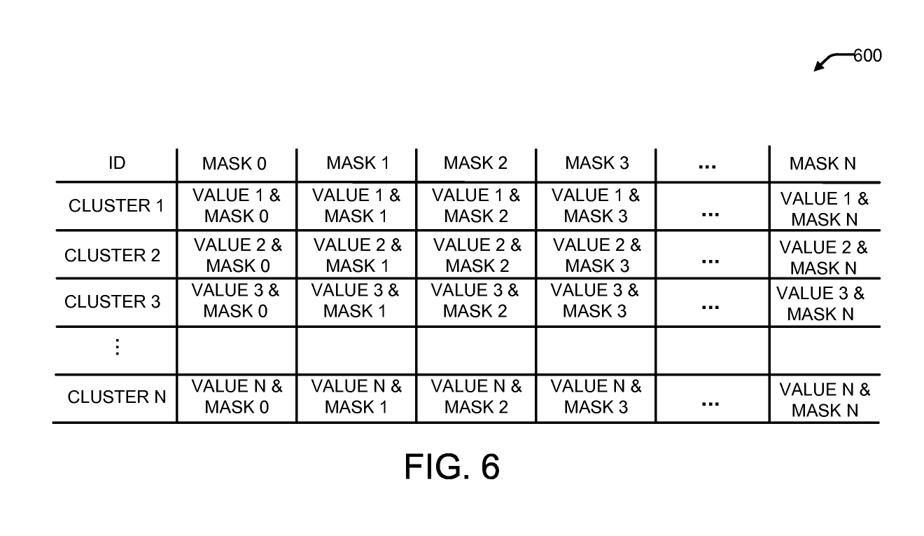

Turning now to FIG. 6, the multiple bit sequences of a fingerprint and associated matching is explained in more detail. FIG. 6 is an exemplary table 600 showing organized cluster information for efficient fingerprint similarity determination. As shown, individual clusters CLUSTER 1-CLUSTER N of messages are represented at rows in the table 600. Each cluster includes a fingerprint associated therewith of a fixed length, in this example, a sequence of 2 bits of 64 hashes. Values for individual bit sequences of fixed length for each cluster fingerprint are represented at columns in the table 600. So, for example, the CLUSTER 1 fingerprint has been divided by a series of bit masks MASK 1-MASK N, with each value associated therewith located in a requisite series. Each MASK <i> may be represented by a binary bitmask. Furthermore, each VALUE <i> is a fingerprint bit sequence from the CLUSTER <i>. Accordingly, in the illustrated example, VALUE 1 & MASK 0 is the fingerprint value bits and MASK 0, VALUE 1 & MASK 1 is the fingerprint value bits and MASK 1, and so on. The CLUSTER 2-CLUSTER N fingerprints are represented in the same manner.

It follows that the received fingerprint is divided into similar sequences for efficient comparison. Thus, rather than employing a brute-force comparison of individual bits of each received fingerprint to the many existing clusters, an efficient comparison for individual sequences is employed. According to one embodiment, if any single bit sequence of the received fingerprint matches an associated bit sequence of any cluster, block 506 determines a likely match. Thus, only a twenty-five percent match is sufficient for returning a positive match in some embodiments. Varying levels of similarity may also be employed without departing from the scope of embodiments. Furthermore, more or fewer bit sequences or sequences of different lengths than those described above may also be employed without departing from the scope of the various embodiments disclosed herein.

Turning back to FIG. 5, if no cluster match is determined at block 506, a new cluster is created based on the bit sequences of the fingerprint at block 508, and the method 500 ceases at block 512. Alternatively, if a cluster match is found, the method 500 determines if a similarity threshold has been met at block 510. The similarity threshold as described above is twenty-five percent in some embodiments. In other embodiments a closer match may be used, for example, fifty, seventy-five, or one hundred percent. If the similarity threshold has not been met, a new cluster may be created at block 508. However, if the similarity threshold has been met, the message fingerprint is associated with the matching cluster at block 512 and the method ceases at block 514.

As noted in step 410 above, the method 500 includes classifying messages. FIG. 7 is a flowchart showing aspects of one illustrative method 700 for classifying electronic messages, according to one embodiment presented herein.

The method 700 includes counting features within a message cluster at block 702. For example, features may include any suitable features of a cluster of messages including, but not limited to, distinct message subject count and rate, distinct sender count and rate, distinct sender domain count and rate, distinct sender secondary domain count and rate, distinct sender host count and rate, distinct sender secondary host count and rate, distinct sender origin IP count and rate, distinct sender origin count and subnet mask rate, distinct recipient domain rate, distinct recipient secondary domain rate, send to the same domain count and rate, sender host format score, and/or current spam verdict rate. It should be appreciated that the message classifications noted above are relatively easily discerned through counting of these features.

Upon counting the features within the cluster, the method 700 includes determining a cluster type based on the counted features at block 704. If the cluster type has a current classification as determined at block 706, the method 700 includes publishing the cluster classification and fingerprint bit sequences at block 708, and ceases at block 710. If the cluster type is not classified, the method 700 includes publishing the cluster features for supervised machine learning at block 712.

It should be appreciated that the logical operations described above are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

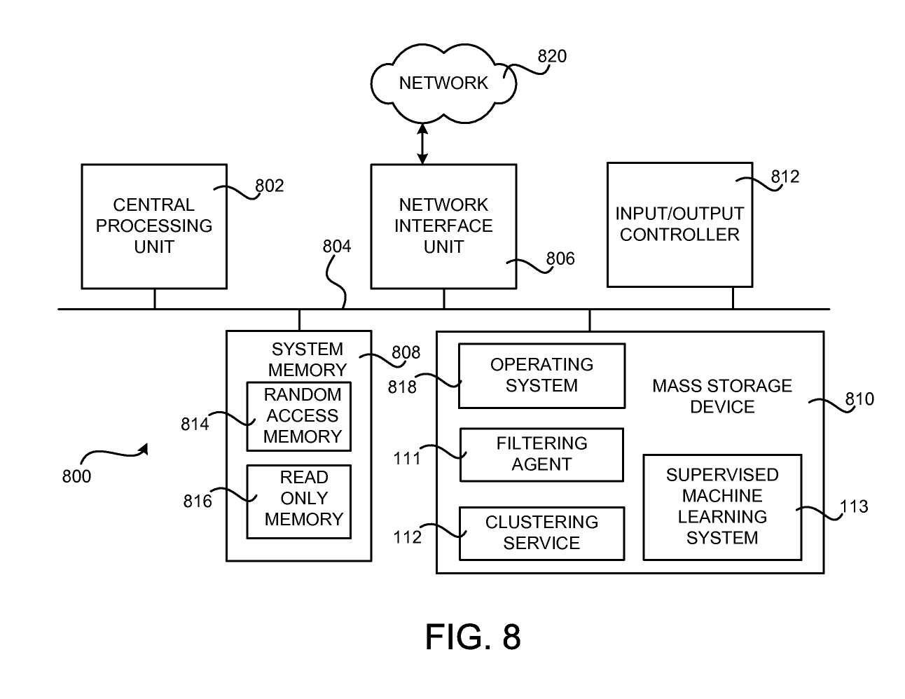

FIG. 8 shows an illustrative computer architecture for a computer 800 capable of executing the software components described herein for filtering messages in the manner presented above. The computer architecture shown in FIG. 8 illustrates a conventional desktop, laptop, or server computer and may be utilized to execute any aspects of the software components presented herein described as executing on the mail processing system 120.

The computer architecture shown in FIG. 8 includes a central processing unit 802 (“CPU”), a system memory 808, including a random access memory 814 (“RAM”) and a read-only memory (“ROM”) 816, and a system bus 804 that couples the memory to the CPU 802. A basic input/output system containing the basic routines that help to transfer information between elements within the computer 800, such as during startup, is stored in the ROM 816. The computer 800 further includes a mass storage device 810 for storing an operating system 818, application programs, and other program modules, which are described in greater detail herein.

The mass storage device 810 is connected to the CPU 802 through a mass storage controller (not shown) connected to the bus 804. The mass storage device 810 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 800. For purposes of the claims, the phrase “computer storage medium,” and variations thereof, does not include waves or signals per se and/or communication media.

According to various embodiments, the computer 800 may operate in a networked environment using logical connections to remote computers through a network such as the network 820. The computer 800 may connect to the network 820 through a network interface unit 806 connected to the bus 804. It should be appreciated that the network interface unit 806 may also be utilized to connect to other types of networks and remote computer systems. The computer 800 may also include an input/output controller 812 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 810 and RAM 814 of the computer 800, including an operating system 818 suitable for controlling the operation of a networked desktop, laptop, or server computer. The mass storage device 810 and RAM 814 may also store one or more program modules, such as the filtering agent 111, clustering service 112, and supervised machine learning system 113, described above. The mass storage device 810 and the RAM 814 may also store other types of program modules and data.

Based on the foregoing, it should be appreciated that technologies for filtering electronic messages are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for filtering electronic messages, the method comprising:
receiving an electronic message for transmission to a recipient;
generating a fingerprint for the electronic message, the fingerprint being a fixed length of appended bits selected from hash values determined from a plurality of hash functions applied to separate textual words included in the electronic message;
determining if the electronic message is associated with a known cluster of previously transmitted electronic messages; and
filtering the electronic message based on the determining.

2. The method of claim 1, wherein generating the fingerprint comprises:
removing noisy characters from the message;
dividing the message into a plurality of shingles absent the noisy characters;
performing the plurality of hash functions on each shingle of the plurality of shingles to create a plurality of hash values associated with each shingle; and
generating the fingerprint based on the plurality of hash functions.

3. The method of claim 2, wherein generating the fingerprint further comprises:
determining a final hash value for each hash value across all shingles of the plurality of shingles; and
selecting a predetermined number of bits from each final hash value as bits for the fingerprint.

4. The method of claim 3, wherein determining the final hash value comprises determining a minimum hash value associated with each hash function across all shingles of the plurality of shingles.

5. The method of claim 1, wherein determining if the electronic message is associated with a known cluster comprises:
dividing the fingerprint into a plurality of bit sequences; and
comparing each bit sequence of the plurality of bit sequences to an associated bin of bit sequences for the known clusters.

6. The method of claim 5, wherein the plurality of bit sequences are each a first length, and wherein each associated bin of bit sequences includes bit sequences of the first length.

7. The method of claim 1, further comprising classifying the known cluster based on message features of the known cluster if the electronic message is associated with a known cluster of previously transmitted electronic messages; and
publishing an electronic mail filter configured to filter future messages received based on the classifying and the known cluster.

8. The method of claim 7, wherein the classifying the known cluster comprises:
counting the message features for the known cluster;
determining if an existing message classification exists based on the counting; and
if an existing message classification exists, publishing the classification and an associated fingerprint for the known cluster.

9. The method of claim 7, wherein the message features comprise origin and destination information associated with the known cluster.

10. The method of claim 7, the message classification comprises at least a classification that messages associated with the known cluster are noisy messages.

11. A computer-readable storage medium having computer executable instructions stored thereon which, when executed by a computer, cause the computer to:
receive an electronic message for transmission to a recipient;
generate a fingerprint for the electronic message, the fingerprint being a fixed length of appended bits selected from hash values determined from a plurality of hash functions applied to separate textual words included in the electronic message;
determine if the electronic message is associated with a known cluster of previously transmitted electronic messages;
classify the known cluster based on message features of the known cluster in response to determining the electronic message is associated with the known cluster; and
publish an electronic mail filter configured to filter future messages received based on the classification and the known cluster.

12. The computer-readable storage medium of claim 11, wherein generate the fingerprint comprises:
remove noisy characters from the message;
divide the message into a plurality of shingles absent the noisy characters;
perform the plurality of hash functions on each shingle of the plurality of shingles to create a plurality of hash values associated with each shingle; and
generate the fingerprint based on the plurality of hash functions.

13. The computer-readable storage medium of claim 12, wherein generate the fingerprint further comprises:
determine a final hash value for each hash value across all shingles of the plurality of shingles; and
select a predetermined number of bits from each final hash value as bits for the fingerprint.

14. The computer-readable storage medium of claim 13, wherein determine the final hash value comprises determining a minimum hash value associated with each hash function across all shingles of the plurality of shingles.

15. The computer-readable storage medium of claim 11, wherein determine if the electronic message is associated with a known cluster comprises:
divide the fingerprint into a plurality of bit sequences; and
compare each bit sequence of the plurality of bit sequences to an associated bin of bit sequences for the known clusters.

16. The computer-readable storage medium of claim 15, wherein the plurality of bit sequences are each a first length, and wherein each associated bin of bit sequences includes bit sequences of the first length.

17. The computer-readable storage medium of claim 11, wherein the electronic mail filter includes at least a portion of the fingerprint of the electronic message.

18. The computer-readable storage medium of claim 11, wherein classify the known cluster comprises:
count the message features for the known cluster;
determine if an existing message classification exists based on the counting; and
if an existing message classification exists, publish the classification and an associated fingerprint for the known cluster.

19. The computer-readable storage medium of claim 17, wherein the message features comprise origin and destination information associated with the known cluster and wherein the message classification comprises at least a classification that messages associated with the known cluster are noisy messages.

20. A mail processing system configured to distribute electronic messages from a plurality of client computers to a plurality of recipients, the system comprising:
at least one computer executing an electronic messaging service configured to receive the electronic messages from the plurality of client computers, the electronic messaging service further configured to
divide each message into a plurality of shingles absent noisy characters,
perform a plurality of hash functions on each shingle of the plurality of shingles to create a plurality of hash values associated with each shingle, and
generate a message fingerprint for each message based on the plurality of hash functions;
at least one computer executing a clustering service configured to receive each message fingerprint from the electronic messaging service, the clustering service further configured to,
divide each fingerprint into a plurality of bit sequences,
compare each bit sequence of the plurality of bit sequences to an associated bin of bit sequences for known clusters of previously transmitted electronic messages, and
determine if a similarity threshold between each fingerprint and the known clusters has been met; and
at least one computer executing a filtering agent configured to filter the electronic messages based on filter information received from the clustering service.
